(19) United States
(12) Patent Application Publication
(10) Pub. No.: US 2012/0240409 A1
(43) Pub. Date: Sep. 27, 2012

(54) TRIMMER BLADE

(75) Inventors: Tomoyuki Inoue, Shiga (JP); Hidekazu Sueyoshi, Shiga (JP); Kenichi Muraki, Shiga (JP)

(73) Assignee: Panasonic Corporation, Kadoma-shi (JP)

(21) Appl. No.: 13/416,031

(22) Filed: Mar. 9, 2012

(30) Foreign Application Priority Data
Mar. 22, 2011 (JP) 2011-062450

(51) Int. Cl. B26B 19/06

(52) U.S. Cl. 30/43.92

(57) ABSTRACT

A trimmer blade comprises a fixed blade unit and a movable blade unit. Then, said fixed blade unit comprises a comb-shaped blade section having a plurality of blades and a plurality of gullets, and said plurality of blades are arranged alternately with said plurality of gullets. Then, said movable blade unit comprises a comb-shaped blade section having a plurality of blades and a plurality of gullets, and said plurality of blades are arranged alternately with said plurality of gullets, and said movable blade unit is configured to slide on said fixed blade unit while reciprocating. A width of each gullet of said movable blade unit is set so that at least two gullets of said fixed blade unit fall inside each gullet of said movable blade unit, as viewed from a direction perpendicular to a sliding surface between said movable blade unit and said fixed blade unit.

### BACKGROUND OF THE INVENTION

1. Field of the Invention

The invention relates generally to trimmer blades and, more particularly, to a trimmer blade which comprises a comb-shaped fixed blade unit and a comb-shaped movable blade unit.

2. Description of the Related Art

Generally, a trimmer blade comprises a comb-shaped fixed blade unit and a comb-shaped movable blade unit which is configured to slide on the fixed blade unit while reciprocating. Then, as shown in FIGS. 10A and 10B, the trimmer blade cuts a hair inserted into a gullet 10 of the fixed blade unit by using a blade 11 of the fixed blade unit and a blade 31 of the movable blade unit. In the figures, a sign 4 shows a skin.

Here, in regard to the number of a plurality of blades arranged alternately with a plurality of gullets, the fixed blade unit is typically about the same as the movable blade unit, as shown in Japanese Patent Application Laid-Open No. 2001-096081. However, in such a configuration, many hairs are cut with edges of blades of the movable blade unit before being deeply inserted into gullets of the fixed blade unit. In this case, after notches are produced in the many hairs by the edges of the movable blade unit, the many hairs are cut so as to split. Thus, there is a high possibility that cut surfaces of the many hairs are not flat and uniform. Then, the split parts of the many hairs make a skin less smooth. As a result, this is not preferred as a trimmer blade for cutting unwanted hairs.

In a trimmer blade shown in Japanese Patent Application Laid-Open No. 11-197372, an interval between adjacent blades of a fixed blade unit, that is, a width of each gullet of a fixed blade unit are set to be larger than that of the above-mentioned trimmer blade, and thereby more hairs are effectively inserted into gullets of the fixed blade unit. However, in this case, after a hair 2 is inserted into a gullet 10 between blades 11, 11 of the fixed blade unit, the hair 2 may be pushed down by means of moving of a blade 31 of the movable blade unit, as shown in FIGS. 11A and 11B. Thus, hairs may be often treated without being cut, and such a configuration may reduce cutting efficiency.

### SUMMARY OF THE INVENTION

It is an object of the present invention to provide a trimmer blade, which can provide good hair insertion efficiency and good cutting efficiency, and can cut so that most of hairs have smooth and flat cut surfaces.

A trimmer blade of the present invention comprises a fixed blade unit and a movable blade unit. Then, said fixed blade unit comprises a comb-shaped blade section having a plurality of blades and a plurality of gullets, and said plurality of blades are arranged alternately with said plurality of gullets. Then said movable blade unit comprises a comb-shaped blade section having a plurality of blades and a plurality of gullets, and said plurality of blades are arranged alternately with said plurality of gullets. Then, said movable blade unit is configured to slide on said fixed blade unit while reciprocating. A width of each gullet of said movable blade unit is set so that at least two gullets of said fixed blade unit fall inside each gullet of said movable blade unit, as viewed from a direction perpendicular to a sliding surface between said movable blade unit and said fixed blade unit.

In this configuration, the trimmer blade can cut hairs in a state where hairs are deeply inserted into gullets of said fixed blade unit, and can cut so that most of hairs have smooth cut surfaces. Then, the trimmer blade can reduce the number of hairs having cut surfaces, each of which is cut so as to split except for a part. Therefore, the trimmer blade can improve smoothness of a skin after cutting hairs, and can increase user's satisfaction.

Preferably, a ratio between the number of said plurality of blades of said movable blade unit and the number of said plurality of blades of said fixed blade unit is set to be within a range of 1:3 to 1:5, and then the number of gullets of said fixed blade unit falling inside each gullet of said movable blade unit is within a range of 3 to 5, as viewed from the direction perpendicular to said sliding surface.

Preferably, a ratio between a thickness of each blade of said movable blade unit and a width of each gullet of said movable blade unit is set to be within a range of 1:4 to 1:6.

Then, preferably, said movable blade unit is located closer to a side of a contact surface contacting with a skin than said fixed blade unit.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is an enlarged plan view showing a trimmer blade according to an embodiment of the present invention;

FIG. 2 is a longitudinal sectional view showing said trimmer blade according to said embodiment of the present invention;

FIG. 3A is a front view showing a fixed blade unit of said trimmer blade according to said embodiment of the present invention;

FIG. 3B is a plan view showing said fixed blade unit of said trimmer blade according to said embodiment of the present invention;

FIG. 3C is a side view showing said fixed blade unit of said trimmer blade according to said embodiment of the present invention;

FIG. 4A is an enlarged view of “A” section shown in FIG. 3A;

FIG. 4B is an enlarged view of “B” section shown in FIG. 3B;

FIG. 5A is a front view showing a movable blade unit of said trimmer blade according to said embodiment of the present invention;

FIG. 5B is a plan view showing said movable blade unit of said trimmer blade according to said embodiment of the present invention;

FIG. 5C is a side view showing said movable blade unit of said trimmer blade according to said embodiment of the present invention;

FIG. 6A is an enlarged view of “C” section shown in FIG. 5A;

FIG. 6B is an enlarged view of “D” section shown in FIG. 5B;

FIG. 7 is an exploded perspective view showing said trimmer blade according to said embodiment of the present invention;

FIG. 8 is a front view showing a whole configuration including a drive unit and said trimmer blade according to said embodiment of the present invention;

FIG. 9 is a cross-sectional view showing said whole configuration including said drive unit and said trimmer blade according to said embodiment of the present invention;

FIG. 10A is a drawing for explaining cutting of a hair performed by a fixed blade unit and a movable blade unit of the conventional trimmer blade;

FIG. 10B is a drawing for explaining cutting of a hair performed by said fixed blade unit and said movable blade unit of the conventional trimmer blade;

FIG. 11A is a drawing for explaining cutting of a hair performed by a movable blade unit and a fixed blade unit which has a larger pitch between adjacent blades of the conventional trimmer blade; and

FIG. 11B is a drawing for explaining cutting of a hair performed by said movable blade unit and said fixed blade unit which has a larger pitch between adjacent blades of the conventional trimmer blade.

### DETAILED DESCRIPTION OF EXEMPLARY EMBODIMENTS

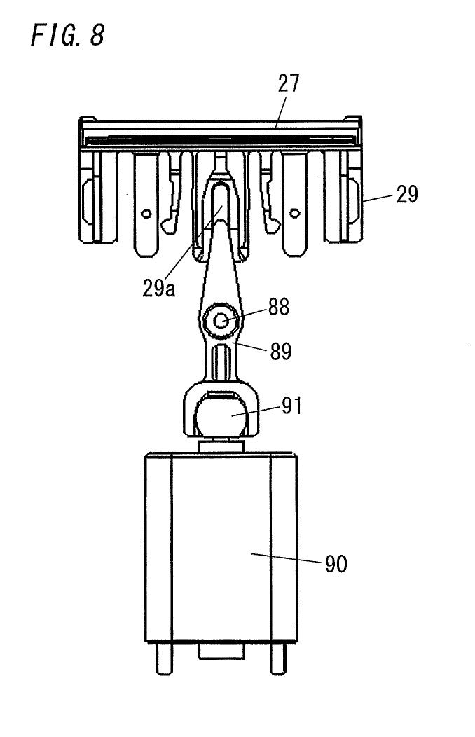

Hereinafter, an embodiment of the present invention is explained referring to figures. As shown in FIG. 7, a trimmer blade of the embodiment comprises a comb-shaped fixed blade unit 1, a comb-shaped movable blade unit 3, a trimmer base frame 29, a spring member 28 for pressing the movable blade unit 3 to the fixed blade unit 1, and a cover 27.

The trimmer base frame 29 is a molding product, and is provided in its top face with two bosses 29d, 29d, which are located apart from each other in a longitudinal direction of its top face. A boss 29d has a function to determine the position of the fixed blade unit 1, and to guide the reciprocating movable blade unit 3, and to reduce flexure of the cover 27 when the cover 27 is forced on the trimmer base frame 29. Then, grooves 29c, 29c are formed in both ends of the longitudinal direction of said top face, respectively. These grooves 29c, 29c are formed in order to attach the spring member 28 and the cover 27, and are provided with projections for determining the position of the spring member 28 and for retaining the spring member 28. Furthermore, the trimmer base frame 29 is provided in the center of the longitudinal direction of its top face with a projection 29b, which is located so as to project from an upper end of a drive rod fitting portion 29a.

The spring member 28 is made of a thin plate and comprises four spring pieces, each of which produces a spring pressure for pressing the movable blade unit 3 to the fixed blade unit 1. Further, the spring member 28 is provided in both ends of its longitudinal direction with arms, respectively. Then, the arms are engaged with the above-mentioned projections formed in the grooves 29c, 29c, respectively, and thereby the spring member 28 is attached to the trimmer base frame 29.

The cover 27 is a molding product, and is provided in both ends of its longitudinal direction with projected hooks, and then the projected hooks are engaged with the grooves 29c, 29c, respectively, and thereby the cover 27 is coupled with the trimmer base frame 29. As a result, the fixed blade unit 1, the movable blade unit 3 and the spring member 28 are retained without being uncoupled between the trimmer base frame 29 and the cover 27. Then, the cover 27 is provided in its surface facing the trimmer base frame 29 with small projections (not shown), which face top faces of bosses 29d, 29d of the trimmer base frame 29, respectively. These small projections reduce flexure of the cover 27 and prevent an increase in a pressing load with respect to driving of the movable blade unit 3, when the cover 27 of the trimmer blade is pressed to a skin surface.

The trimmer blade is assembled with these members as described below. That is, the fixed blade unit 1 is attached to the trimmer base frame 29, while a grinding surface of the blade section of the fixed blade unit 1 is set as an upper surface. In this time, the bosses 29d, 29d in an upper surface of the trimmer base frame 29 are engaged with square sockets 21a, 21a located in both sides of the center of the fixed blade unit 1, respectively, and thereby the position of the fixed blade unit 1 is determined.

Then, the movable blade unit 3 is placed on the fixed blade unit 1, while a grinding surface of the blade section of the movable blade unit 3 is set as a lower surface. In this time, the projection 29b in the center of the trimmer base frame 29 is engaged with a central hole 22a of the movable blade unit 3, and thereby the movable blade unit 3 is coupled with the drive rod fitting portion 29a of the trimmer base frame 29. Then, the bosses 29d, 29d of the trimmer base frame 29 are located in long holes 22b, 22b for guiding reciprocation, respectively.

Then, the arms in both ends of the spring member 28 are engaged with the trimmer base frame 29, and further the cover 27 is attached to the trimmer base frame 29 through the spring member 28.

As described below, the trimmer blade cuts hairs while a surface of the cover 27 is pressed to a skin. Therefore, the surface of the cover 27 is made of a material having a pleasant feel and is formed into a shape having a pleasant feel.

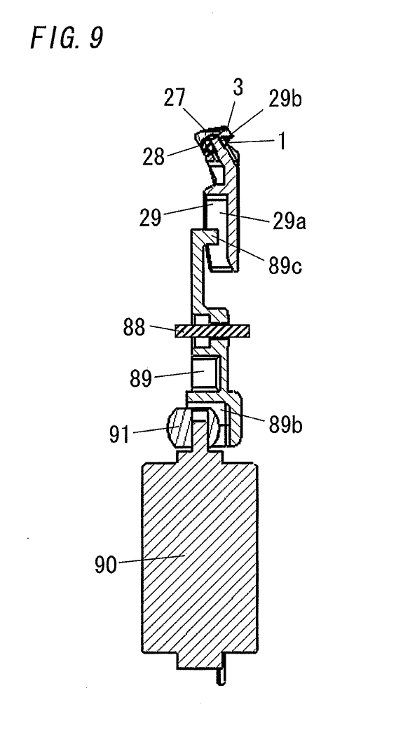

As shown in FIGS. 8 and 9, the drive rod fitting portion 29a of the trimmer base frame 29 is engaged with a drive pin 89c located in one end of a drive rod 89, which is swingably supported by a shaft 88. An eccentric cam 91 attached to an output shaft of a motor 90 is engaged with a cam receiver 89b located in the other end of the drive rod 89. The drive rod 89 swings about the shaft 88 with rotating of the eccentric cam 91 driven by the motor 90. Then, reciprocation of the drive rod 89 is transmitted to the movable blade unit 3 through the drive rod fitting portion 29a, and thus the movable blade unit 3 also reciprocates. In addition, the configuration for driving the trimmer blade is not limited to one example shown in the figures.

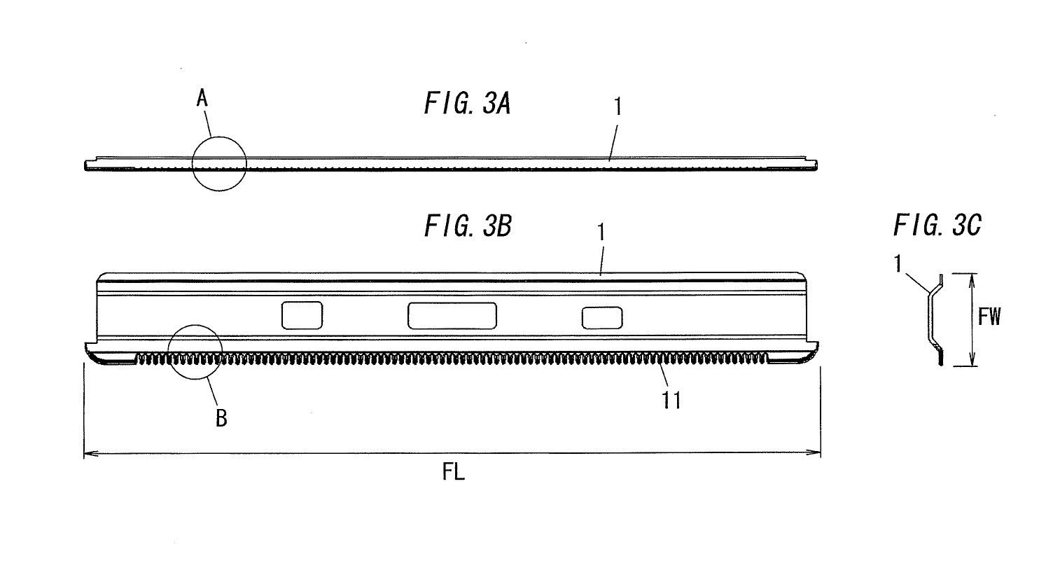

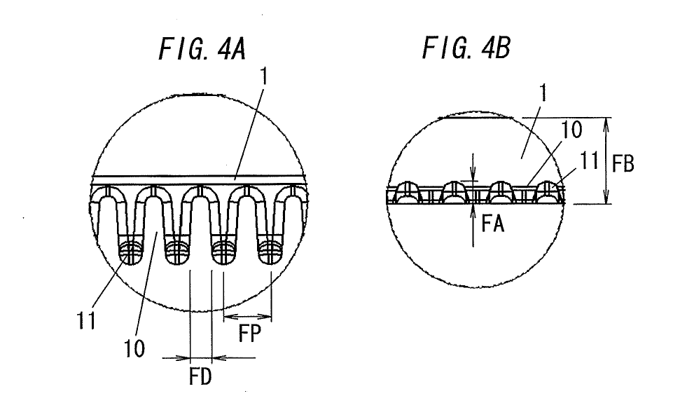

Then, the fixed blade unit 1 and the movable blade unit 3 are explained below. As shown in FIGS. 3A to 3C and 4A, 4B, the fixed blade unit 1 is made of a plate and comprises a blade section having a plurality of blades 11 and a plurality of gullets 10. Then, the plurality of blades 11 are arranged alternately with the plurality of gullets 10. Then, a center of a width direction of the fixed blade unit 1 is flexed into U-shape, and bottom faces in both ends of the width direction are set to be about the same in height. Here, the bottom faces in the both ends are set to be the same in height by means of surface grinding, and thereby the fixed blade unit 1 can cut hairs well. Then, the bottom faces in the both ends are set to be about the same in area, and that is, are also set to be about the same in grinding area. Therefore, the bottom faces can prevent load's bias and can reduce variation in height when being ground.

Then, the above-mentioned blade section is formed in one end side's edge of the width direction, and has a plurality of blades 11 and a plurality of gullets 10, which are arranged alternately. Here, a width of each blade 11 is about the same as a width FD of each gullet 10. The width FD of each gullet 10 is set to be relatively-small to adapt to a width of a hair, which is a target of unwanted hair removal. Incidentally, a pitch FP between adjacent blades 11, 11 is less than or equal to 0.4 [mm].

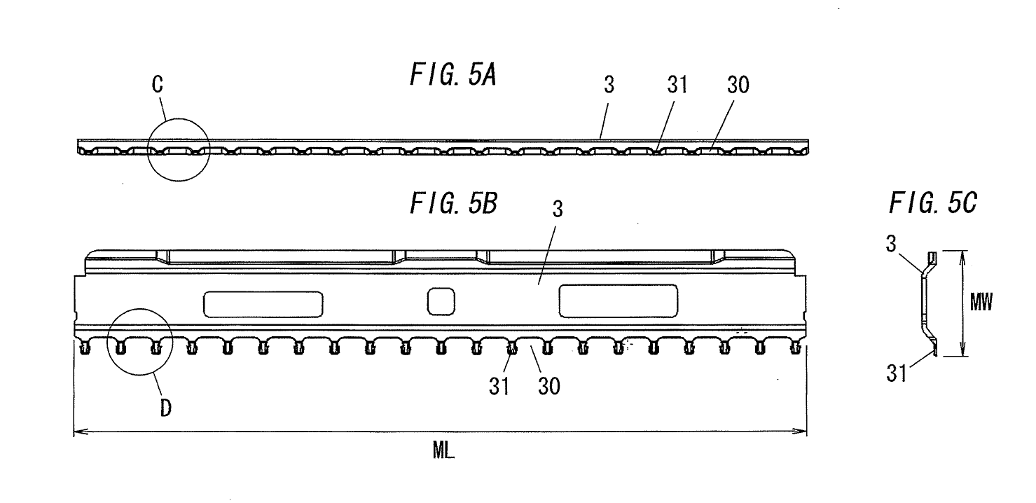

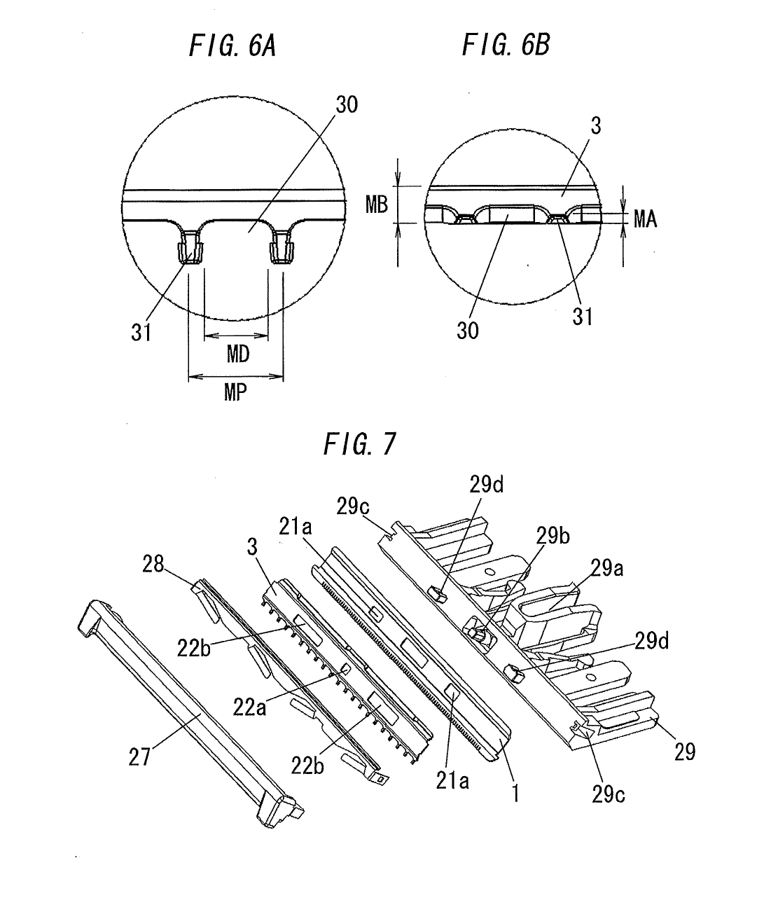

As shown in FIGS. 5A to 5C and 6A, 6B, the movable blade unit 3 is made of a plate, and comprises a blade section having a plurality of blades 31 and a plurality of gullets 30 which are arranged alternately. The blade section is formed in one end side's edge of the width direction of the movable blade unit 3. Then, as well as the fixed blade unit 1, a center of the width direction of the movable blade unit 3 is flexed into U-shape, and bottom faces in both ends of the width direction are set to be about the same in height. Here, the bottom faces in the both ends are set to be the same in height by means of surface grinding, and thereby the movable blade unit 3 can cut hairs well. Then, the bottom faces in the both ends are set to be about the same in area, and thereby the bottom faces can prevent load's bias and can reduce variation in height when being ground.

Then, in the movable blade unit 3 of the present invention, a width MD of a gullet 30 is set to be more than twice as large as a width of a blade 31, and thereby a pitch MP between adjacent blades 31, 31 is set to be more than twice as large as a pitch FP between adjacent blades 11, 11 of the fixed blade unit 1, and preferably to be more than three times as large as the pitch FP, as can be expected from the figures (the pitch MP is set to 1.5 [mm] in the figures).

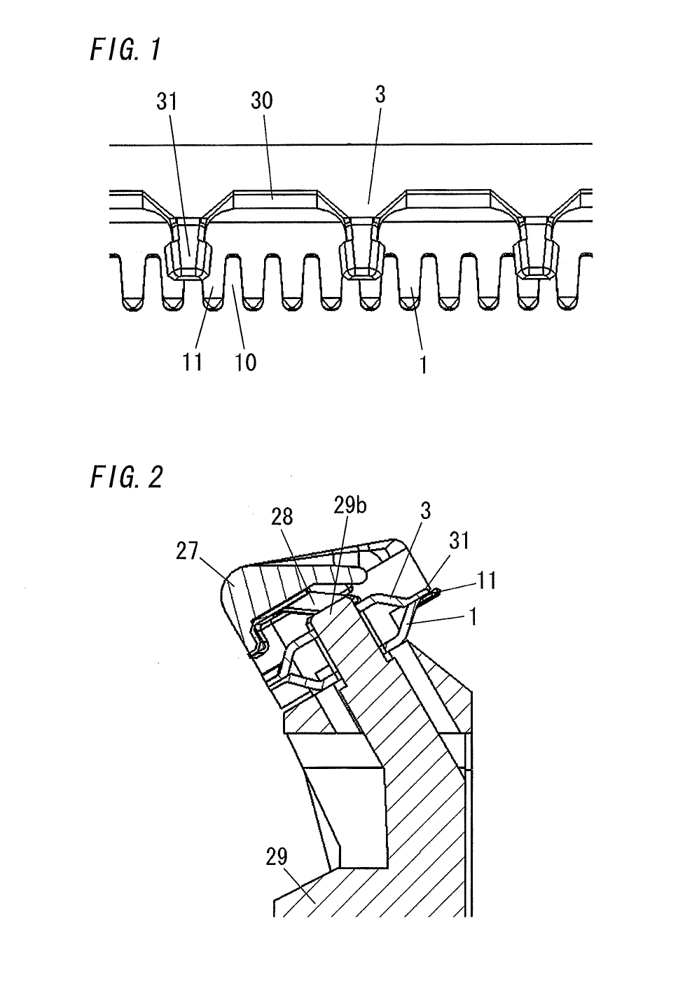

Therefore, as shown in FIG. 1, when the trimmer blade is assembled, a width MD of each gullet 30 of the movable blade unit 3 is set so that at least two blades 11 or at least two gullets 10 (more than or equal to three in the figures) of the fixed blade unit 1 fall between adjacent blades 31, 31 of the movable blade unit 3, that is, inside each gullet 30, as viewed from a direction perpendicular to a sliding surface between the movable blade unit 3 and the fixed blade unit 1.

Therefore, when the trimmer blade is moved in a state where the cover 27 is pressed to a skin and the movable blade unit 3 is reciprocated at a frequency of 5000 to 6000 [times/min], more hairs are cut by blades 11 of the fixed blade unit 1 and blades 31 of the movable blade unit 3 while being deeply inserted into gullets 10 of the fixed blade unit 1. That is, more hairs are cut well along width directions of hairs by the movable blade unit 3 and the fixed blade unit 1, and have smooth cut surfaces. Then, the trimmer blade can reduce the number of hairs having cut surfaces, each of which is cut so as to split except for a part. Thus, the trimmer blade can prevent that a skin loses smoothness due to hairs having such split parts in edge faces, and there is a high possibility that smoothness of skin surface is stably improved.

In addition, the conventional trimmer blade is configured so that a fixed blade unit 1 is located closer to a side of a skin than a movable unit 3. However, as can be expected from the above explanation, the trimmer blade of the present embodiment is configured so that a movable blade unit 3 is located closer to a side of a skin than a fixed blade unit 1 when a cover 27 is pressed to a skin. A thickness MA of each blade 31 of the movable blade unit 3 is less than a thickness FA of each blade 11 of the fixed blade unit 1 and further each gullet 30 of the movable blade unit 3 has a large width, and thereby a skin surface can approach to a sliding surface between the movable blade unit 3 and the fixed blade unit 1. Thus, the trimmer blade can make a shorter hair than the conventional trimmer blade by means of cutting.

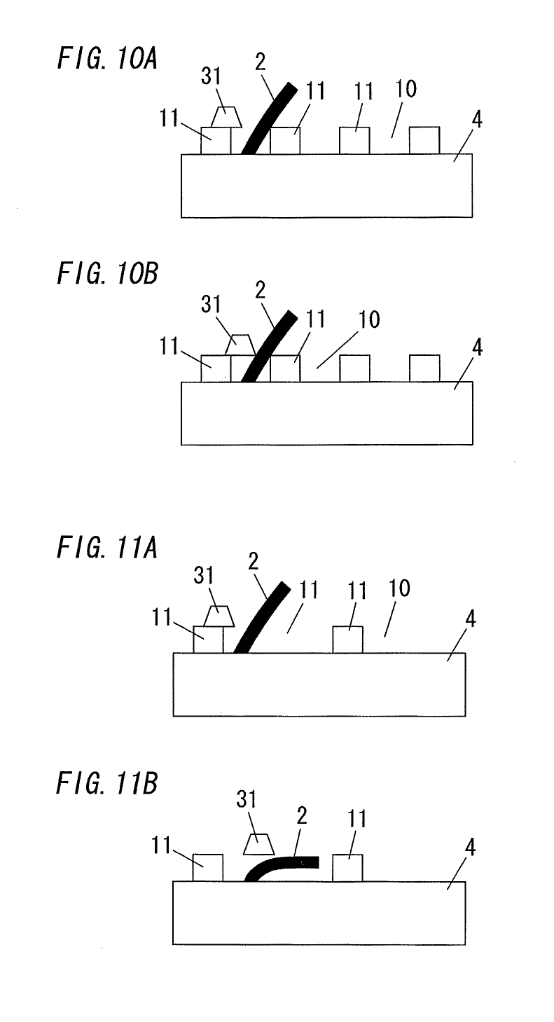

Then, although the movable blade unit 3 is located closer to a side of a skin when the cover 27 is pressed to a skin, a hair inserted into a gullet 10 of the fixed blade unit 1 is cut between a blade 31 of the movable blade unit 3 and a blade 11 of the fixed blade unit 1 without being pushed down in the gullet 10, as well as FIGS. 10A and 10B. Thus, the trimmer blade reduces an increase in the number of hairs, which are not cut by means of being pushed down, unlike FIGS. 11A and 11B.

Then, a stroke of reciprocation of the movable blade unit 3 is set to be larger than a pitch MP between adjacent blades 31, 31 of the movable blade unit 3 (for example, the pitch MP is 1.5 [mm] and the stroke is 1.7 [mm]). Thus, the trimmer blade can certainly cut a hair inserted into a gullet 10 of the fixed blade unit 1.

Here, if the pitch MP between adjacent blades 31, 31 is too large, such a configuration causes a decrease in the number of times a blades 31 of the movable blade unit 3 slides on a certain gullet 10 per unit time. As a result, when the trimmer blade cut hairs while being moved along a skin, a hair inserted into a gullet 30 leaves the gullet 30 before being cut by reciprocation of the movable blade unit 3. For this reason, preferably, the number of gullets 10 falling between adjacent blades 31, 31 (inside a gullet 30) is set to about 5 at the most, as viewed from a direction perpendicular to a sliding surface between the movable blade unit 3 and the fixed blade unit 1. Then, if the number is equal to or more than 6, there is a need to set a stroke of reciprocation of the movable blade unit 3 larger than a width of each gullet 30. However, it is difficult to secure such a stroke.

Then, if the number of gullets 10 falling between adjacent blades 31, 31 (inside a gullet 30) is less than 3 as viewed from the direction perpendicular to said sliding surface, more hairs are cut so as to split before being deeply inserted into gullets 10 while depending on a speed of the trimmer blade moved along a skin and the above frequency of the movable blade unit 3. Thereby, it is difficult to obtain smoothness in a skin after cutting hairs.

Thus, preferably, the number of gullets 10 falling between adjacent blades 31, 31 (inside a gullet 30) is within a range of 3 to 5, as viewed from the direction perpendicular to said sliding surface. In other words, preferably, a ratio between the number of all blades 31 of the movable blade unit 3 and the number of all blades 11 of the fixed blade unit 1 is set to be within a range of 1:3 to 1:5. Then, a trimmer blade having such a ratio is preferred as a trimmer blade for cutting unwanted hairs. However, in consideration of the quality of a hair, the speed of the trimmer blade and the frequency of movable blade unit 3, the number of gullets 10 falling between adjacent blades 31, 31 (inside a gullet 30) may be set to 2, as viewed from the direction perpendicular to said sliding surface.

In regard to the movable blade unit 3, it is further preferred that a ratio between its thickness MA and a width MD of each gullet 30 is set to be within a range of 1:4 to 1:6 in order to secure intensity of blades 31 and improve cutting efficiency.

In regard to the fixed blade unit 1, it is preferred that a ratio between its thickness FA and a width FD of each gullet 10 is set to about 1:1.

Then, in regard to the fixed blade unit 1, preferably, when a ratio between a size FL of its longitudinal direction and a width FW of its width direction is equal to or less than 2:1, a ratio between a thickness FA and a whole height FB is set to equal to or more than 1:2 in order to secure whole stiffness property of the trimmer blade. Similarly, in regard to the movable blade unit 3, preferably, when a ratio between a size ML of its longitudinal direction and a width MW of its width direction is equal to or less than 2:1, a ratio between a thickness MA and a whole height MB is set to equal to or more than 1:2 in order to secure whole stiffness property of the trimmer blade. There is a need to grind a sliding surface so that the movable blade unit 3 smoothly slides on the fixed blade unit 1. If the stiffness property is low, it is difficult to perform the grinding process stably. However, the trimmer blade having the above ratios can reduce variation between a thickness in the center and thicknesses in both ends of longitudinal directions of the fixed blade unit 1 and variation between a thickness in the center and thicknesses in both ends of longitudinal directions of the movable blade units 3 after the grinding process, and thus can cut hairs well.

Although the present invention has been described with reference to certain preferred embodiments, numerous modifications and variations can be made by those skilled in the art without departing from the true spirit and scope of this invention, namely claims.

1. A trimmer blade, comprising:
a fixed blade unit comprising a comb-shaped blade section having a plurality of blades and a plurality of gullets, said plurality of blades being arranged alternately with said plurality of gullets; and
a movable blade unit comprising a comb-shaped blade section having a plurality of blades and a plurality of gullets, said plurality of blades being arranged alternately with said plurality of gullets, said movable blade unit being configured to slide on said fixed blade unit while reciprocating,
wherein a width of each gullet of said movable blade unit is set so that at least two gullets of said fixed blade unit fall inside each gullet of said movable blade unit, as viewed from a direction perpendicular to a sliding surface between said movable blade unit and said fixed blade unit.

2. The trimmer blade as claimed in claim 1,
wherein a ratio between the number of said plurality of blades of said movable blade unit and the number of said plurality of blades of said fixed blade unit is set to be within a range of 1:3 to 1:5,
wherein the number of gullets of said fixed blade unit falling inside each gullet of said movable blade unit is within a range of 3 to 5, as viewed from the direction perpendicular to said sliding surface.

3. The trimmer blade as claimed in claim 1,
wherein a ratio between a thickness of each blade of said movable blade unit and a width of each gullet of said movable blade unit is set to be within a range of 1:4 to 1:6.

4. The trimmer blade as claimed in claim 2,
wherein a ratio between a thickness of each blade of said movable blade unit and a width of each gullet of said movable blade unit is set to be within a range of 1:4 to 1:6.

5. The trimmer blade as claimed in claim 1,
wherein said movable blade unit is located closer to a side of a contact surface contacting with a skin than said fixed blade unit.

6. The trimmer blade as claimed in claim 2,
wherein said movable blade unit is located closer to a side of a contact surface contacting with a skin than said fixed blade unit.

7. The trimmer blade as claimed in claim 3,
wherein said movable blade unit is located closer to a side of a contact surface contacting with a skin than said fixed blade unit.

8. The trimmer blade as claimed in claim 4,
wherein said movable blade unit is located closer to a side of a contact surface contacting with a skin than said fixed blade unit.
